(19) United States
(12) Patent Application Publication
(10) Pub. No.: US 2006/0149423 A1
(43) Pub. Date: Jul. 6, 2006

(54) Method for satisfying variable power demand

(76) Inventors: Scott Donald Barnicki, Kingsport, TN (US); Lauren Donohoe Moyer, Kingsport, TN (US); Craig Alan Schmidt, Kingsport, TN (US); Ronnie Delane Lilly, Kingsport, TN (US); Nathan West Moock, Kingsport, TN (US); William Lewis Trapp, Kingsport, TN (US)

Correspondence Address: ERIC D. MIDDLEMAS;EASTMAN CHEMICAL COMPANY, P. O. BOX 511, KINGSPORT, TN, 37662-5075, US

(21) Appl. No.: 11/311,766

(22) Filed: Dec. 19, 2005

Related U.S. Application Data
(63) Continuation-in-part of application No. 11/214,366, filed on Aug. 29, 2005.
(60) Provisional application No. 60/626,777, filed on Nov. 10, 2004.

(51) Int. Cl. G05D 11/00

(52) U.S. Cl. 700/286

(57) ABSTRACT

A process for satisfying variable power demand and a method for maximizing the monetary value of a synthesis gas stream are disclosed. One or more synthesis gas streams are produced by gasification of carbonaceous materials and passed to a power producing zone to produce electrical power during a period of peak power demand or to a chemical producing zone to produce chemicals such as, for example, methanol, during a period of off-peak power demand. The power-producing zone and the chemical-production zone which are operated cyclically and substantially out of phase in which one or more of the combustion turbines are shut down during a period of off-peak power demand and the syngas fuel diverted to the chemical producing zone. This out of phase cyclical operational mode allows for the power producing zone to maximize electricity output with the high thermodynamic efficiency and for the chemical producing zone to maximize chemical production with the high stoichiometric efficiency. The economic potential of the combined power and chemical producing zones is enhanced.

### CROSS REFERENCE TO RELATED APPLICATIONS

This application is a continuation-in-part of U.S. patent application Ser. No. 11/214,366, filed Aug. 29, 2005, which claims the benefit of U.S. Provisional Application Ser. No. 60/626,777, filed Nov. 10, 2004.

### FIELD OF THE INVENTION

This invention relates to a process for the production of regularly varying amounts of electric power and chemicals from synthesis gas. More particularly, this invention relates to a process for intermittently producing electrical power and chemicals in which one or more combustion turbines are shut down during a period of off-peak power demand and the synthesis gas supplying these turbines is diverted to the production of chemicals.

### BACKGROUND OF THE INVENTION

Electric power production and distribution networks can generally be characterized as needing to respond to power demand patterns which vary over time. Such demand patterns generally rise and fall cyclically over daily, weekly and even annual periods, with the precise degree of variation being substantially different in various localities. The value of electricity generated at peak load often can be a factor of two or more higher than off-peak generation. It is not uncommon for the base load and peak load facilities of an electrical utility network to use different technologies and or fuels.

In order to maximize economic potential, the various electric power generating units within a given network of units are often dispatched, i.e., assigned a variable load factor in order of lowest marginal cost, as the system load factor varies over time. Operation of a network of generation units in dispatch mode allows the producer to minimize the cost of production of the system as a whole. The most valuable generating units are those which have low marginal cost and the ability to vary capacity factor significantly, quickly, and without substantial cost penalty.

As is well known to those in the art, current conventional electric power generation plants frequently utilize natural gas, fuel oil, and hydrocarbon liquids as the sources of energy for the generation of electrical power. The most thermodynamically efficient modern power plants combine a high temperature combustion-generating turbine (Brayton) cycle with a lower temperature water/steam generating turbine (Carnot) cycle. These so-called combined cycle plants are particularly well-suited for cyclical power generation in dispatch mode as the combustion and steam turbines are designed for frequent on-off operation. The hydrocarbon fuels and oils are liquids and readily storable during periods of off-peak or no power generation. Alternatively for natural gas, the existing and extensive long range distribution and pipeline system provides a reservoir for meeting demand variations.

However, these fuels, which are particularly attractive for supplying increased electric power during peak demand periods, are no longer as inexpensive and in such plentiful supply as they have been in the past. Now, due to the high cost of crude petroleum, refined petroleum products and natural gas, as well as the unreliability of the sources and limited reserves of these fuels, it has become necessary that different energy sources be explored and new techniques for the effective utilization of all sources of energy be developed.

Coal and other solid carbonaceous fuels (e.g., petroleum coke, biomass, paper pulping wastes), are in great abundance and relatively inexpensive and are logical materials for the art to investigate as primary energy sources for the generation of electric power. Coal, the primary source of heat to generate electric and mechanical power, originally had fallen out of favor because of problems involved in handling, transport and storage, and because of its content of ash, sulfur and other impurities which can create environmental and other emissions control problems. But now, because of its lower cost and more secure domestic supply, coal is returning to favor, and more efficient and cleaner means of utilization are under investigation.

Coal is usually combusted with air and the heat produced is used to generate a high pressure steam which is expanded in a turbine to generate mechanical or electrical energy. The electric industry has developed a variety of large, highly efficient generators which can be driven by expanding steam. Coal fired steam generators, however, are not well suited for producing greatly varying amounts of electricity, but rather are usually designed for more of a base (i.e., substantially constant) load. Coal combustors are also poorly suited to interrupted requirements. Usually they are preferred for base load operations because of the lower fuel cost.

Coal and other solid carbonaceous materials, as mentioned above, further contain a substantial amount of sulfur compounds, the combustion of which creates serious environmental problems. Since enormous volumes of low pressure gas are produced in the combustion of these sulfur-bearing coals, it is expensive to remove the polluting sulfur compounds such as SO₂ and SO₃ following combustion. These and other problems have thus spurred the search for coal gasification processes which will produce a clean fuel gas in which the sulfur compounds have been removed from the fuel prior to combustion.

Coal and other solid carbonaceous materials can be gasified with the resulting gasification products (syngas) cleaned and used to generate power in a combined cycle operation. A so-called integrated gasification combined cycle (IGCC) power plant consists of a fuel (usually coal or pet coke) gasification block and a combined cycle power block. Such a combined cycle is essentially identical to that used with natural gas fuels. The generation of syngas, however, is much more complicated than drawing from a natural gas pipeline. With an IGCC, the solids grinding and preparation, gasification, ash handling, gas cooling, and sulfur removal steps are capital intensive, and difficult and costly to shut down and start up frequently. They are designed to operate continuously with limited turndown capacity, and inherently favor substantially continuous base-load operation. Even if the gasification block could be turned off as readily as pipeline-based natural gas, idling of the gasifier block and subsequent under utilization of the assets results in a prohibitive economic penalty on power production. Thus, there is a mismatch between the variable power production ability of the combined cycle block and the required base-loaded operation of the gasification block. IGCC units are considered in the art as base-load units, without the ability to dispatch to intermediate load factors.

Numerous variations have been proposed in the prior art to address the issue variable power demand coupled with an IGCC process. A common approach is to operate the gasification block at an essentially constant base-load capacity factor. The crude syngas thus generated is cleaned to remove the majority of the sulfurous compounds and other impurities, followed by feeding the cleaned syngas to a so-called partial-conversion, “once-through” (no gas recycle) chemical synthesis reaction, with the unconverted syngas burned for direct base load power generation, thereby replacing more expensive, equivalently cleaned fuels. The synthesized chemical is stored and later used as fuel for gas turbine-steam turbine combined cycle system during the peak demand periods. Co-produced chemicals exemplified in the art are ammonia, methanol, dimethyl ether, and Fischer-Tropsch products.

Unfortunately, a once-through process is limited by the stoichiometry of the chemical reaction and process efficiency in the proportion of storable fuel which can be produced from the syngas. The gasification process produces a synthesis gas having, typically, a 0.7/1 to 1.2/1 ratio of H₂ to CO together with lesser amounts of CO₂, H₂S, methane and other inerts. Since the synthesis of methanol, dimethyl ether, and Fischer-Tropsch hydrocarbons consumes two moles of H₂ per mole of CO, it is readily apparent that even if H₂ conversion is complete, this stoichiometric requirement will limit the conversion of the syngas stream. Since only a limited fraction, typically about 50% of the available hydrogen is converted in the once-through synthesis mode, the process will convert a maximum of only about 25% of the available syngas to a storable liquid chemical fuel. Chemical equilibrium and kinetics limitations further constrain the potential achievable conversions at compositions, temperatures, and pressures at which the reactions may be carried out in practice.

Examples of such partial conversion processes wherein a chemical is co-produced are disclosed in U.S. Pat. No. 4,566,267 for ammonia co-production, U.S. Pat. No. 5,392,594 for methanol, U.S. Pat. Nos. 3,986,349 and 4,092,825 for Fischer-Tropsch hydrocarbons, and U.S. Pat. No. 4,341,069 for dimethyl ether co-production. Weber et al in “Methanol Coproduction: Strategies for Effective Use of IGCC Power Plants”, Proceedings of the American Power Conference (1988), 50, 288-93, disclose that the optimal conversion of syngas for such a methanol partial conversion process is about 20-35% of the available syngas. Thus, average base (off-peak) to peak load variation is 50 to 100% of the output of the gasification block, with a maximum variation of 50 to 140%.

Furthermore, the thermal efficiency of power generation via a combined cycle plant is degraded by first producing a chemical fuel, then combusting this fuel. Typically the overall thermal efficiency of an IGCC as measured against the BTU content of the feedstock carbonaceous material to net power generation is on the order of 38-46%. Production of fuel chemical from the syngas and subsequent combustion of this fuel introduces additional thermodynamic inefficiencies into the IGCC process. The resultant fuel (i.e., methanol, dimethyl ether, or hydrocarbon) is in a lower energy state than the original syngas and when combusted produces less energy per unit quantity than the original syngas.

Attempts have been made to improve the conversion of syngas by recycling streams enriched in H₂ or CO as exemplified by U.S. Pat. Nos. 4,946,477, 5,284,878 and 5,392,594, but the maximum syngas conversions disclosed are less than 75%. The equilibrium limit for DME formation is greater than for methanol, so conversions up to about 77% are achievable as disclosed, for example, in U.S. Pat. No. 4,341,069. DME, however, is normally a gaseous component and must be chilled and compressed for storage, with the concomitant higher capital cost.

Many other variations on the basic theme of partial syngas conversion with limited base to peak loading capability have been proposed, including adding further chemical synthesis steps, heat integration schemes to improve thermal efficiency (with corresponding higher capital costs), and syngas storage. For example, acetic acid may be produced from methanol and carbon monoxide in the tail gas. Additional conversion of the syngas is achieved, but the resulting product (acetic acid) is no longer suitable for use as a peaking fuel in the combustion turbogenerator. In another example, part of the syngas may be converted to methyl formate. Conversions of about 68% are achievable, but with significant additional capital is required for carbon monoxide enrichment, hydrogenalysis of methyl formate, methyl formate dissociation, and two separate combustion turbine systems.

Other concepts include storing syngas for later use as peaking fuel. Syngas containing large amounts of hydrogen, however, cannot be liquefied. Thus, massive and expensive gaseous storage devices would be required for useful amounts of syngas peaking fuel storage. Improved thermodynamic efficiency may be accomplished by integrating the steam produced in the partial conversion methanol process into the IGCC steam cycle. Off-peak power also may be used to electrolyze water to hydrogen and oxygen gases. The hydrogen is combined with CO or CO₂ to produce methanol which is stored for as a peaking fuel. This process suffers from low thermodynamic efficiency of both the electrolysis and methanol synthesis steps.

The methods and processes disclosed above do not adequately address the problem of varying power loads for gasification-based power plants. Schemes relying on continuous co-production of chemicals and power with subsequent burning of the co-produced chemical for peak power loading allow for relatively limited variations in power load factor, typically 50-140% of the base to peak load factor. “Once through” chemical processes enable production of relatively small amounts of chemicals. For example, once-through methanol production amounts to 12-30% of the carbon monoxide/hydrogen feed gas and thus do not efficiently use the gas. Because of lack of economy of scale for chemical production, once-through chemical processes generally have a high relative capital cost for chemical production. When the co-produced chemical is burned for peak power generation, overall thermal efficiency of the power cycle is reduced by several percentage points for every 10% of syngas thus converted. Thus, a method of variable power production is needed that maintains the highest thermal efficiency of power cycle during power production, while converting unused gaseous fuels to chemicals at the highest stoichiometric and capital efficiency during chemical production.

### SUMMARY OF THE INVENTION

We have discovered that a variable power demand can be efficiently satisfied in a syngas fueled power plant by shutting down one or more power producing combustion turbines during a period of off-peak power demand and using the syngas fuel for chemical production. Accordingly, a process for intermittently producing electrical power and chemicals, is set forth comprising:
(a) continuously feeding an oxidant stream comprising at least 90 volume % oxygen into one or more gasifiers;
(b) reacting the oxidant stream with a carbonaceous material in the one or more gasifiers to produce one or more synthesis gas streams comprising carbon monoxide, hydrogen, carbon dioxide, and sulfur-containing compounds;
(c) passing at least one of the synthesis gas streams to a power-producing zone comprising at least one combustion turbine during a period of peak power demand to produce electrical power;
(d) passing at least one of the synthesis gas streams to a chemical-producing zone during a period of off-peak power demand to produce chemicals;
(e) shutting down the at least one combustion turbine during the period of off-peak power demand.
   The gas, comprising carbon monoxide, carbon dioxide, and hydrogen (abbreviated herein as “syngas”), is consumed in a power-producing zone and a chemical producting zone which are operated cyclically and substantially out of phase. During periods of off-peak power demand, one or more of the combustion turbines which produce electrical power is shut down and its syngas fuel is directed to a chemical producing zone. In this fashion the throughput of the syngas is kept at a substantially base-loaded value, fully utilizing the expensive syngas-generating equipment, while allowing for the dispatch of a cyclical and variable power loading factor, and maximizing chemical production with syngas not required for power generation. Such a novel combination provides a power generating operation of unusual flexibility, offers substantial economic advantages, and is particularly responsive to present power variation requirements faced by electric power producers. For example, in one embodiment of the invention, a power plant may be operated at 100% of its maximum power producing capacity at peak power demands during the day and fueled entirely by syngas. The syngas may be provided by any method known to persons skilled in the art but, typically, may be supplied by gasification of coal or other carbonaceous substances. For example, in another embodiment of the invention, the power producing zone may comprise an integrated gasification combined cycle (abbreviated herein as “IGCC”) power plant. This is in direct contrast to existing power plant configurations, wherein the power generating facility is operated in base-loaded mode with little load-following capability.

Our process provides for up to 100% of the synthesis gas to be directed to a chemical producing zone to convert one or more of the hydrogen, carbon monoxide, or carbon monoxide to a reaction product. For example, in one embodiment of the instant process, the synthesis gas may be used to produce methanol, alkyl formates, ammonia, dimethyl ether, hydrogen, Fischer-Tropsch products, or a combination thereof. In another embodiment, the chemical producing zone is a methanol-producing zone which may comprise a fixed bed or liquid slurry phase methanol reactor. In yet another embodiment of the invention, the process further comprises steps for the efficient startup and shutdown of a methanol producing zone and the combustion turbines during the transition periods between off-peak and peak power demands by gradually diverting the syngas to or from the methanol producing zone while cofeeding methanol to the combustion turbines to maintain their electrical output capacity at 50% or more of their maximum capacity.

### BRIEF DESCRIPTION OF DRAWINGS

FIG. 1 illustrates a schematic flow diagram for one embodiment for co-production of variable power and methanol.

### DETAILED DESCRIPTION

In a general embodiment, the present invention provides a novel process for intermittently producing electrical power and chemicals, comprising:
(a) continuously feeding an oxidant stream comprising at least 90 volume % oxygen into one or more gasifiers;
(b) reacting the oxidant stream with a carbonaceous material in the one or more gasifiers to produce one or more synthesis gas streams comprising carbon monoxide, hydrogen, carbon dioxide, and sulfur-containing compounds;
(c) passing at least one of the synthesis gas streams to a power-producing zone comprising at least one combustion turbine during a period of peak power demand to produce electrical power;
(d) passing at least one of the synthesis gas streams to a chemical-producing zone during a period of off-peak power demand to produce chemicals; and
(e) shutting down the at least one combustion turbine during the period of off-peak power demand.
   In the process of the invention, carbonaceous materials can be continuously reacted with oxygen in one or more gasifiers to produce syngas at a substantially constant rate. “Peak power demand”, as used herein within the context of the present invention, means the maximum power demand on the power producing zone within a given 24 hour period of time. The “period of peak power demand”, as used herein, means one or more intervals of time within the above 24 hour period in which the power demand on the power producing zone is at least 90% of the maximum power demand. “Period of off-peak power demand”, as used herein, means one or more intervals of time within a given 24 hour period in which the power demand on the power producing zone is less than 90% of the peak power demand as defined above. The term “substantially constant rate”, as used herein, is understood to mean that the gas is provided continuously in an uninterrupted manner and at a constant level. “Substantially constant rate”, however, is not intended to exclude normal interruptions that may occur because of, for example, maintenance, start-up, or scheduled shut-down periods. For the purposes of this invention, sulfur refers to any sulfur-containing compound, either organic or inorganic in nature. Examples of such sulfur-containing compounds are exemplified by hydrogen sulfide, sulfur dioxide, sulfur trioxide, sulfuric acid, elemental sulfur, carbonyl sulfide, mercaptans, and the like. The phrase “maximum capacity fuel requirements”, as used herein, is understood to mean the fuel needed to operate an electrical power plant at its maximum capacity. As used herein, maximum capacity is intended to mean the greatest possible quantity of power that can be produced by the power plant. Maximum capacity can be, but is not necessarily, equivalent to design capacity in that the design capacity of power plant may be increased by improvements and debottlenecking of process equipment. Typically, a power plant will operate at its maximum capacity at peak power demands during the daylight hours. The gaseous fuel, or syngas, comprising carbon dioxide, carbon monoxide, and hydrogen, of the instant invention may be provided by any of a number of methods known in the art including steam or carbon dioxide reforming of carbonaceous materials such as natural gas or petroleum derivatives; partial oxidation or gasification of carbonaceous materials, such as petroleum residuum, bituminous, subbituminous, and anthracitic coals and cokes, lignite, oil shale, oil sands, peat, biomass, petroleum refining residues or cokes, and the like.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used in the specification and the appended claims, the singular forms “a,” “an” and “the” include their plural referents unless the context clearly dictates otherwise. For example, references to a “turbine,” or a “chemical,” is intended to include the one or more turbines, or chemicals. References to a composition or process containing or including “an” ingredient or “a” step is intended to include other ingredients or other steps, respectively, in addition to the one named.

By “comprising” or “containing” or “including”, we mean that at least the named compound, element, particle, or method step, etc., is present in the composition or article or method, but does not exclude the presence of other compounds, catalysts, materials, particles, method steps, etc, even if the other such compounds, material, particles, method steps, etc., have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

The process of the invention includes continuously feeding an oxidant stream comprising at least 90 volume % oxygen into one or more gasifiers and reacting the oxidant stream with a carbonaceous material in the one or more gasifiers to produce one or more synthesis gas streams comprising carbon monoxide, hydrogen, carbon dioxide, and sulfur-containing compounds. Any one of several known gasification processes can be incorporated into the method of the instant invention. These gasification processes generally fall into broad categories as laid out in Chapter 5 of “Gasification”, (C. Higman and M. van der Burgt, Elsevier, 2003). Examples are moving bed gasifiers such as the Lurgi dry ash process, the British Gas/Lurgi slagging gasifier, the Ruhr 100 gasifier; fluid-bed gasifiers such as the Winkler and high temperature Winkler processes, the Kellogg Brown and Root (KBR) transport gasifier, the Lurgi circulating fluid bed gasifier, the U-Gas agglomerating fluid bed process, and the Kellogg Rust Westinghouse agglomerating fluid bed process; and entrained-flow gasifiers such as the Texaco, Shell, Prenflo, Noell, E-Gas (or Destec), CCP, Eagle, and Koppers-Totzek processes. The gasifiers contemplated for use in the process may be operated over a range of pressures and temperatures between about 1 to about 103 bar absolute (abbreviated herein as “bara”) and 400° C. to 2000° C., with preferred values within the range of about 21 to about 83 bara and temperatures between 500° C. to 1500° C. Depending on the carbonaceous or hydrocarbonaceous feedstock used therein and type of gasifier utilized to generate the gaseous carbon monoxide, carbon dioxide, and hydrogen, preparation of the feedstock may comprise grinding, and one or more unit operations of drying, slurrying the ground feedstock in a suitable fluid (e.g., water, organic liquids, supercritical or liquid carbon dioxide). Typical carbonaceous materials which can be oxidized to produce syngas include, but are not limited to, petroleum residuum, bituminous, subbituminous, and anthracitic coals and cokes, lignite, oil shale, oil sands, peat, biomass, petroleum refining residues, petroleum cokes, and the like. For maximum economic value and thermodynamic efficiency, it is advantageous to size gasifiers to supply at least 90%, or in another example, at least 95% of the maximum capacity fuel requirements of the power-producing zone.

Oxygen, or another suitable gaseous stream containing substantial amounts of oxygen is charged to the gasifier, along with the carbonaceous or hydrocarbonaceous feedstock. The oxidant stream may be prepared by any method known in the art, such as cryogenic distillation of air, pressure swing adsorption, membrane separation, or any combination therein. The purity of oxidant stream typically is at least 90 volume % oxygen; for example, the oxidant stream may comprise at least 95 volume % oxygen or, in another example at least 98 volume % oxygen.

The oxidant stream and the prepared carbonaceous or hydrocarbonaceous feedstock are introduced into one or more gasifiers wherein the oxidant is consumed and the feedstock is substantially converted into one or more synthesis gas (syngas) streams comprising carbon monoxide, hydrogen, carbon dioxide, water, and various impurities such as, for example, sulfur-containing compounds. For example, the syngas may comprise water and other impurities, for example, hydrogen sulfide, carbonyl sulfide, methane, ammonia, hydrogen cyanide, hydrogen chloride, mercury, arsenic, and other metals, depending on the feedstock source and gasifier type. The gasification block comprises one or more gasifiers, high temperature gas cooling equipment, ash/slag handling equipment, and gas filters, scrubbers. The precise manner in which the oxidant and feedstock are introduced into the gasifier is within the skill of the art; it is preferred that the process will be run continuously and at a substantially constant rate.

At least one of the synthesis gas streams is passed to a power-producing zone during a period of peak power demand to produce electrical power. The power producing zone comprises a means for converting chemical and kinetic energies in the syngas feed to electrical or mechanical energy, typically in the form of at least one turboexpander, also referred to hereinafter as “combustion turbine”. Typically, the power-producing zone will comprise a combined cycle system as the most efficient method for converting the energy in the syngas to electrical energy comprising a Brayton cycle and a Carnot cycle for power generation. In the combined cycle operation, the gaseous fuel is combined with an oxygen-bearing gas, combusted, and fed to one or more combustion turbines to generate electrical or mechanical energy. The hot exhaust gases from the combustion turbine or turbines are fed to one or more heat recovery steam generators (HRSG) wherein a fraction of the thermal energy in the hot exhaust gases is recovered as steam. The steam from the one or more HRSG's along with any steam generated in other sections of the process (i.e., by recovery of exothermic heat of chemical reactions) is fed to one or more steam turboexpanders to generate electrical or mechanical energy, before rejecting any remaining low level heat in the turbine exhaust to a condensation medium. Numerous variations on the basic combined cycle operation are known in the art. Examples are the HAT (humid air turbine) cycle and the Tophat cycle. All are suitable for use without limitation in the power producing zone of the instant invention.

The ability to turn down the capacity factor of a combustion turbine is dictated by many factors including load-dependent thermodynamic efficiency, mechanical efficiencies, and pollution emissions, as well as economic drivers. Typically, the combustion turbines are advantageously operated at 50% or more of their full capacity. For example, the combustion turbine may be operated at 60% or more of full capacity, typically at 70% or more of their full capacity, and more typically at 80% or more of their full capacity. In accordance with the process of the invention, at least one combustion turbine may be shut down during periods of off-peak power demand and at least one of the synthesis gas streams may be passed instead to a chemical-producing zone to produce chemicals. For example, there may be more than one period of off-peak power demand within a 24 hour period. Thus, a combustion turbine may be shut down more than one time within a given 24 hour period. By shutting down at least one combustion turbine during these periods of off-peak power demand instead of operating the turbine in an inefficient or uneconomical regime, the gasifier can be operated efficiently at a constant rate and the maximum thermodynamic and economic value of the syngas realized.

For example, a power producing zone comprising two combustion turbines, might operate at 90% or greater of full capacity. As demand for power drops, it can be advantageous for economic reasons (i.e., low price of power) or because of thermodynamic inefficiency to shut one or more combustion turbines. Therefore, according to the process of the invention, rather than continue to operate one of the turbines in an inefficient and/or uneconomical manner, the turbine is shut down and synthesis gas feed stream passed instead to a chemical producing zone to produce chemicals. Thus, instead of using the syngas stream to produce electrical power with a turbine operating at an inefficient capacity factor, the syngas is used to produce chemicals which may be, for example, sold on the market or used to supplement the fuel requirements of the combustion turbines. The chemical producing zone may be used to produce any chemical that is efficiently obtained from a syngas feedstock such as, for example, methanol, alkyl formates, ammonia, dimethyl ether, hydrogen, Fischer-Tropsch products, or a combination of one or more of these chemicals. For example, in one embodiment of the invention, the chemical producing zone is a methanol-producing zone.

The methanol-producing zone can comprise any type of methanol synthesis plant that are well known to persons skilled in the art and many of which are widely practiced on a commercial basis. Most commercial methanol synthesis plants operate in the gas phase at a pressure range of about 25 to about 140 bara using various copper based catalyst systems depending on the technology used. A number of different state-of-the-art technologies are known for synthesizing methanol such as, for example, the ICI (Imperial Chemical Industries) process, the Lurgi process, and the Mitsubishi process. Liquid phase processes are also well known in the art. Thus, the methanol producing zone according to the present invention may comprise a fixed bed methanol reactor, containing a solid or supported catalyst, or liquid slurry phase methanol reactor, which utilizes a slurried catalyst in which metal or supported catalyst particles are slurried in an unreactive liquid medium such as, for example, mineral oil.

The syngas stream is typically supplied to a methanol reactor at the pressure of about 25 to about 140 bara, depending upon the process employed. The syngas then reacts over a catalyst to form methanol. The reaction is exothermic; therefore, heat removal is ordinarily required. The raw or impure methanol is then condensed and may be purified to remove impurities such as higher alcohols including ethanol, propanol, and the like or, burned without purification as fuel. The uncondensed vapor phase comprising unreacted syngas feedstock typically is recycled to the methanol process feed.

The transition between power production and chemical production is another aspect of the instant invention. For example, during periods of when there may be no methanol production such as, for example during periods of peak power demand, the flow of synthesis gas to the methanol reactor can be stopped. The reactor, which can have a fixed bed or liquid slurry phase format, can be valved off, i.e., shutting off the valves controlling the influent and effluent flows of synthesis gas to and from the methanol reactors. It is desirable, however, to maintain the reactor and catalyst temperatures such that methanol production will start immediately open reintroduction of syngas flow such as, for example, 200° C. or above. Surprisingly it has been found that the thermal mass of the catalyst and reactor itself will maintain the temperature above the desired range for several hours, typically four to ten hours, without further heat addition. It may be necessary, however, to provide additional heat input into the idled reactor. In one embodiment of the invention, for example, the additional heat may be provided by passing at least one heated gas stream that is unreactive under methanol reaction conditions to the fixed bed or liquid slurry phase methanol reactor to maintain the solid or slurried catalyst at an elevated temperature. The term “unreactive”, as used herein, is intended to mean that the components of the gas do not react in the presence of the methanol catalyst to produce an appreciable amount of product (that is, wherein the amount of product is greater than >0.1 mole percent of the total gas), or deleteriously react with the catalyst to reduce its long term activity, selectivity, or lifetime. Examples of heated, unreactives gases that can be used include, but are not limited to, nitrogen, helium, hydrogen, methane, ethane, propane, butane, natural gas, argon, and mixtures thereof. Typically, the solid or slurried catalyst will be maintained at a temperature of at least 150° C. Additional examples of temperatures for the solid or slurried catalyst include, but are not limited to, at least 175° C., at least 200° C., at least 220° C., and at least 250° C. In another example, the temperature of the reactor may be maintained by contacting a heat transfer medium such as, for example, steam or hot water with at least one heat exchange surface of the fixed bed or liquid slurry phase methanol reactor to maintain the solid or slurried catalyst at a temperature of at least 150° C.

For liquid phase slurry reactors, it is advantageous to keep the catalyst suspended in the liquid when the methanol reactor is in idle mode, i.e., during periods of peak power demand. An inert gas, for example nitrogen, may be fed to the reactor in place of the reactive syngas at a velocity and volume such to prevent settling of the catalyst. Methods for calculating the required flow rate to ensure suspension of the catalyst are well-known in the art. When methanol production is to resume, syngas flow is commenced as the nitrogen flow is reduced. Purge from the reactor, which can be initially high, is decreased to normal levels as the amount of nitrogen drops off.

The thermal mass of the slurry fluid, reactor vessel, and catalyst will maintain the temperature above the desired range for several hours, typically four to ten hours, without further heat addition. It may be necessary, however, to provide additional heat input into the idled reactor as described above. For example, the additional heat may be provided by circulation of heated gases (for example nitrogen) through the reactor or by contact of a heat transfer medium (for example hot water or steam) to the heat transfer surfaces of the reactor. For example, in another embodiment of the invention, a portion of at least one of the synthesis gas streams can be passed to the methanol-producing zone during the period of peak power demand to maintain the methanol-producing zone at an elevated temperature through the production of small amounts of methanol. All of the methanol product then can be passed from the methanol-producing zone to the power-producing zone as additional fuel during the period of peak power demand.

Alternatively, it may be desirable to shift the syngas stream gradually from the combustion turbine to the methanol reactor during the transition period from peak power demand to off-peak power demand to avoid any thermal or physical shock to the catalyst or to avoid flaring any excess syngas. The process of the invention, therefore, further comprises gradually diverting all of the synthesis gas stream from at least one combustion turbine to the methanol producing zone while cofeeding methanol to the combustion turbine at a rate sufficient to maintain the combustion turbine at 50% or more of maximum capacity before shutting down the combustion turbine. By “gradual” or “gradually”, as used in context of diverting gas to or from the methanol producing zone, it is meant that the transfer of the syngas stream occurs over a period of time such as, for example, between 5 minutes to several hours as in contrast to transferring the syngas stream instantaneously as might occur, for example, by the rapid manipulation of a valve. The syngas feed to the combustion turbine is gradually diverted to the methanol process while cofeeding enough methanol to maintain the combustion turbine within an efficient operating regime of 50% or more of its full capacity. For example, the turbine can be maintained at 60% or more, 70% or more, 80% or more, or 90% or more of its full capacity. Once the syngas stream is fully directed to the methanol-producing zone, the combustion turbine can be shut down by shutting off the methanol feed.

Similarly, during the transition period from off-peak power demand to peak power demand, all or a portion the syngas stream may be gradually shifted from the methanol or chemical producing zone to at least one combustion turbine. Thus, the process of the invention further comprises gradually diverting up to 100 volume % of at least one synthesis gas stream from the methanol producing zone to at least one combustion turbine during a transition period from off-peak power demand to peak power demand while cofeeding methanol to the combustion turbine sufficient to maintain the combustion turbine at 50% or more of maximum capacity. For example, the turbine can be maintained at 60% or more, 70% or more, 80% or more, or 90% or more of its full capacity. The turbine can be started up by feeding methanol alone. As syngas is diverted from the methanol producing zone to the combustion turbine, methanol is cofed to the combustion turbine to maintain the turbine at 50% or more of its full operating capacity. As sufficient syngas is made available, the methanol cofeed is reduced appropriately and eventually shut off.

The transition from no methanol to full methanol production can occur in less than 1 hour, more typically, less than 30 minutes for either gas or liquid phase reactors. Variations in flow to any methanol purification equipment downstream of the methanol reactor may be alleviated by providing intermediate storage of crude methanol sufficient to last throughout the period low or no methanol production. In this fashion, the downstream purification equipment may be operated at essentially constant rate and sized only to handle the average daily production rate of methanol rather than the peak production rate.

The methanol producing zone also may comprise a steam driven compressor to compress the synthesis gas feed to the desired pressure and circulate gas through the methanol reactor. The steam that is used to drive this compressor typically is supplied from the steam generated in the reactor shell of the methanol reactor when the reactor is operating at or near its capacity limit. It may be advantageous, however, to supply additional steam to the steam driven compressor from sources other than the methanol reactor. For example, the steam driven compressor may be supplied with steam from a heat exchanger associated with a methanol reactor, a water-gas shift reactor, a gasifer, a heat recovery steam generator (HRSG), or a combination of one or more of these heat exchangers during periods of peak and off-peak power demand. For example, during a period of peak power demand, it may be desirable to operate the methanol compressor in order to continue to produce methanol at low rates or to circulate heated gases through the reactor. The methanol reactor shell, under these circumstances, may not provide sufficient steam to operate the steam driven compressor. Additional steam, therefore, may be provided by recovery of heat from a water-gas shift reactor, a gasifer, a heat recovery steam generator (HRSG), or a combination of these sources.

It is often desirable to remove sulfur-containing compounds present in the syngas in a sulfur removal zone before passing the syngas to the chemical producing zone or to the power producing zone to prevent poisoning of any catalysts used in the chemical-producing zone or to reduce sulfur emissions to the environment. The sulfur removal zone may comprise any of a number of methods known in the art for removal of sulfur from gaseous streams. The sulfurous compounds may be recovered from the gaseous feed to the sulfur removal zone by chemical absorption methods, exemplified by using caustic soda, potassium carbonate or other inorganic bases, or alkanol amines. Examples of suitable alkanolamines for the present invention include primary and secondary amino alcohols containing a total of up to 10 carbon atoms and having a normal boiling point of less than about 250° C. Specific examples include primary amino alcohols such as monoethanolamine (MEA), 2-amino-2-methyl-1-propanol (AMP), 1-aminobutan-2-ol, 2-amino-butan-1-ol, 3-amino-3-methyl-2-pentanol, 2,3-dimethyl-3-amino-1-butanol, 2-amino-2-ethyl-1-butanol, 2-amino-2-methyl-3-pentanol, 2-amino-2-methyl-1-butanol, 2-amino-2-methyl-1-pentanol, 3-amino-3-methyl-1-butanol, 3-amino-3-methyl-2-butanol, 2-amino-2,3-dimethyl-1-butanol, and secondary amino alcohols such as diethanolamine (DEA), 2-(ethylamino)-ethanol (EAE), 2-(methylamino)-ethanol (MAE), 2-(propylamino)-ethanol, 2-(isopropylamino)-ethanol, 2-(butylamino)-ethanol, 1-(ethylamino)-ethanol, 1-(methylamino)-ethanol, 1-(propylamino)-ethanol, 1-(isopropylamino)-ethanol, and 1-(butylamino)-ethanol.

Alternatively, sulfur in the gaseous feed to the sulfur removal zone may be removed by physical absorption methods. Examples of suitable physical absorbent solvents are methanol and other alkanols, propylene carbonate and other alkyl carbonates, dimethyl ethers of polyethylene glycol of two to twelve glycol units and mixtures thereof (commonly known under the trade name of Selexol™ solvents), n-methyl-pyrrolidone, and sulfolane. Physical and chemical absorption methods may be used in concert as exemplified by the Sulfinol™ process using sulfolane and an alkanolamine as the absorbent, or the Amisol™ process using a mixture of monoethanolamine and methanol as the absorbent.

The sulfur-containing compounds may be recovered from the gaseous feed to the sulfur removal zone by solid sorption methods using fixed, fluidized, or moving beds of solids exemplified by zinc titanate, zinc ferrite, tin oxide, zinc oxide, iron oxide, copper oxide, cerium oxide, or mixtures thereof. The sulfur removal equipment may be preceded by one or more gas cooling steps to reduce the temperature of the crude syngas as required by the particular sulfur removal technology utilized therein. Sensible heat energy from the syngas may be recovered through steam generation in the cooling train by means known in the art. If necessary for chemical synthesis needs, the chemical or physical absorption processes or solid sorption processes may be followed by an additional method for final sulfur removal. Examples of final sulfur removal processes are adsorption on zinc oxide, copper oxide, or iron oxide.

Typically at least 90 mole percent, more typically at least 95 mole percent, and even more typically, at least 99 mole percent of the total sulfur-containing compounds in the synthesis gas may be removed in the sulfur removal zone. Typically, the chemical production zone requires more stringent sulfur removal, i.e., at least 99.5% removal, to prevent deactivation of chemical synthesis catalysts, more typically the effluent gas from the sulfur removal zone contains less than 5 ppm by volume sulfur. The sulfur removal prior to the power producing zone and the chemical producing zone may be combined and accomplished in the same equipment if desired.

The process of the invention may further comprise removal or reduction of carbon dioxide from at least one of the synthesis gas streams. For example, a portion of the carbon dioxide may be removed before passing the syngas to the chemical producing zone. Removal or reduction of carbon dioxide may comprise any of a number of methods known in the art. Carbon dioxide in the gaseous feed may be removed by chemical absorption methods, exemplified by using caustic soda, potassium carbonate or other inorganic bases, or alkanol amines. Examples of suitable alkanolamines for the present invention include primary and secondary amino alcohols containing a total of up to 10 carbon atoms and having a normal boiling point of less than about 250° C. Specific examples include primary amino alcohols such as monoethanolamine (MEA), 2-amino-2-methyl-1-propanol (AMP), 1-aminobutan-2-ol, 2-amino-butan-1-ol, 3-amino-3-methyl-2-pentanol, 2,3-dimethyl-3-amino-1-butanol, 2-amino-2-ethyl-1-butanol, 2-amino-2-methyl-3-pentanol, 2-amino-2-methyl-1-butanol, 2-amino-2-methyl-1-pentanol, 3-amino-3-methyl-1-butanol, 3-amino-3-methyl-2-butanol, 2-amino-2,3-dimethyl-1-butanol, and secondary amino alcohols such as diethanolamine (DEA), 2-(ethylamino)-ethanol (EAE), 2-(methylamino)-ethanol (MAE), 2-(propylamino)-ethanol, 2-(isopropylamino)-ethanol, 2-(butylamino)-ethanol, 1-(ethylamino)-ethanol, 1-(methylamino)-ethanol, 1-(propylamino)-ethanol, 1-(isopropylamino)-ethanol, and 1-(butylamino)-ethanol.

Alternatively, carbon dioxide in the gaseous feed may be removed by physical absorption methods. Examples of suitable physical absorbent solvents are methanol and other alkanols, propylene carbonate and other alkyl carbonates, dimethyl ethers of polyethylene glycol of two to twelve glycol units and mixtures thereof (commonly known under the trade name of Selexol™ solvents), n-methyl-pyrrolidone, and sulfolane. Physical and chemical absorption methods may be used in concert as exemplified by the Sulfinol™ process using sulfolane and an alkanolamine as the absorbent, or the Amisol™ process using a mixture of an alkanolamine and methanol as the absorbent.

The carbon dioxide removal equipment may be preceded by one or more gas cooling steps to reduce the temperature of the crude syngas as required by the particular carbon dioxide removal technology utilized therein. Sensible heat energy from the syngas may be recovered through steam generation in the cooling train by means known to persons skilled in the art. If necessary for chemical synthesis needs, the chemical or physical absorption processes or solid absorption or adsorption processes may be followed by an additional method for final carbon dioxide removal. Examples of final carbon dioxide removal processes are pressure or temperature-swing adsorption processes.

When required for chemical synthesis, typically at least 60%, more typically, at least 80% of the carbon dioxide in the feed gas is removed in the carbon dioxide removal zone. For example, the process of the invention may further comprise removing the carbon dioxide from at least one of the synthesis gas streams to give a carbon dioxide concentration of about 0.5 to about 10 mole %, based on the total moles of gas in the synthesis gas stream, before passing the syngas to the methanol-producing zone. In another example, the carbon dioxide may be removed from at least one of the syngas streams to a concentration of about 2 to about 5 mole %. Many of the sulfur and carbon dioxide removal technologies are capable of removing both sulfur and carbon dioxide. Thus, the sulfur removal zones and carbon dioxide removal zones may be integrated together to simultaneously remove sulfur and carbon dioxide either selectively, (i.e. in substantially separate product streams) or non-selectively, (i.e., as one combined product stream).

The water-gas shift reaction may be employed to alter the hydrogen to carbon monoxide ratio of the syngas. The process invention thus may further comprise passing up to 100 volume % of one or more synthesis gas streams to a water-gas shift reaction zone before the power or chemical producing zones wherein at least a portion of the carbon monoxide is reacted with water to produce hydrogen and carbon dioxide:
CO+H₂O←→CO₂+H₂
Typically the water-gas shift reaction is accomplished in a catalyzed fashion by methods known in the art. When the water-gas shift reaction zone preceeds the sulfur recovery zone, then the water gas shift catalyst is advantageously sulfur-tolerant. For example, such sulfur tolerant catalysts can include, but are not limited to, cobalt-molybdenum catalysts. Operating temperatures are typically 250° C. to 500° C. Alternatively, the water-gas shift reaction may be accomplished after bulk sulfur removal using high or low temperature shift catalysts. High temperature shift catalysts, for example iron-oxide promoted with chromium or copper, operate in the range of 300° C. to 500° C. Low temperature shift catalysts, for example, copper-zinc-aluminum catalysts, operate in the range of 200° C. to 300° C. Alternatively the water-gas shift reaction may be accomplished without the aid of a catalyst when the temperature of the gas is greater than about 900° C. Because of the highly exothermic nature of the water-gas shift reaction, steam may be generated by recovering heat from the exit gases of the water gas-shift reactor. The water-gas shift reaction may be accomplished in any reactor format known in the art for controlling the heat release of exothermic reactions. Examples of suitable reactor formats are single stage adiabatic fixed bed reactors; multiple-stage adiabatic fixed bed reactors with interstage cooling, steam generation, or cold-shotting; tubular fixed bed reactors with steam generation or cooling; or fluidized beds.

The water gas shift reaction zone may be integrated and combined with the chemical-producing zone or may be physically separate from the chemical-producing zone. For example, when the chemical-producing zone comprises a Fischer-Tropsch reaction that produces hydrocarbons with an iron-based catalyst, it is advantageous for the Fischer-Tropsch synthesis reactor to operate simultaneously and in the same reactor as the water-gas-shift reaction. Further examples of suitable chemical products derived from one or more of hydrogen, carbon monoxide, or carbon dioxide include, but are not limited to, methanol, dimethyl ether, methyl formate, hydrogen, ammonia and its derivatives, and Fischer-Tropsch products.

Another embodiment of the invention is a process for intermittently producing electrical power and methanol, comprising:
(a) continuously feeding an oxidant stream comprising at least 90 volume % oxygen into one or more gasifiers;
(b) reacting the oxidant stream with a carbonaceous material in the one or more gasifiers to produce one or more synthesis gas streams comprising carbon monoxide, hydrogen, carbon dioxide, and sulfur-containing compounds;
(c) passing at least one of the synthesis gas streams to a power-producing zone comprising at least one combustion turbine during a period of peak power demand to produce electrical power;
(d) gradually diverting all of the at least one synthesis gas stream from the at least one combustion turbine to a methanol producing zone during a transition period from peak power demand to off-peak power demand while cofeeding methanol to the combustion turbine at a rate sufficient to maintain the at least one combustion turbine at 50% or more of maximum capacity;
(e) shutting down the at least one combustion turbine during the period of off-peak power demand;
(f) passing at least one of the synthesis gas streams to the methanol-producing zone during a period of off-peak power demand to produce methanol; and
(g) gradually diverting up to 100 volume % of the at least one synthesis gas stream from the methanol producing zone to the at least one combustion turbine during a transition period of off-peak power demand to peak power demand while cofeeding methanol to the at least one combustion turbine sufficient to maintain the combustion turbine at 50% or more of maximum capacity.
   It is understood that the above process comprises the various embodiments of the gasifier, syngas streams, oxidant stream, carbonaceous materials, power-producing zone, sulfur-removal, and carbon dioxide removal are as described hereinabove.

As noted herein, our novel process maximizes the thermodynamic efficiency and economic value of a synthesis gas stream for power production. Thus, another embodiment of the present invention is a method for maximizing monetary value of a synthesis gas stream from a gasification process, comprising:
(a) continuously feeding an oxidant stream comprising at least 95% oxygen into a gasifier;
(b) reacting the oxidant stream with a carbonaceous material in the gasifier to produce a synthesis gas stream;
(c) passing the synthesis gas stream to a power-producing zone comprising at least one combustion turbine during a period of peak power demand;
(d) passing the synthesis gas stream to a methanol-producing zone during a period of off-peak power demand; and
(e) shutting down the at least one combustion turbine during the period of off-peak power demand.
   It is understood that the process includes the various embodiments of the gasifier, syngas streams, oxidant stream, carbonaceous materials, power-producing zone, sulfur-removal, and carbon dioxide removal are as described previously. For example, the gasifiers can be used to oxidize carbonaceous material such as coal or petroleum coke to syngas and can be sized to supply at least 90% of the maximum capacity fuel requirements of the power-producing zone. The purity of oxidant stream typically is at least 90 volume % oxygen, and may comprise at least 95 volume % oxygen or, in another example at least 98 volume % oxygen. The methanol producing zone is as described previously and may comprise, for example, a fixed bed or liquid slurry phase methanol reactor.

For example, as described above, the process may further comprise gradually diverting all of the synthesis gas stream from one or more combustion turbines to the methanol producing zone while cofeeding methanol to the combustion turbine at a rate sufficient to maintain the combustion turbine at 50% or more of maximum capacity before shutting down the combustion turbine. A portion of at least one of the synthesis gas streams also can be passed to the methanol-producing zone during the period of peak power demand to maintain the methanol-producing zone at an elevated temperature through the production of small amounts of methanol. All of the methanol product can then be passed from the methanol-producing zone to the power-producing zone during the period of peak power demand. The syngas may be further purified to remove at least 95 mole percent of the total sulfur-containing compounds present before the power- or chemical-producing zones or, in another example, at least 99 mole percent of the sulfur compounds can be removed. The carbon dioxide also may be removed or its concentration reduced as described herein.

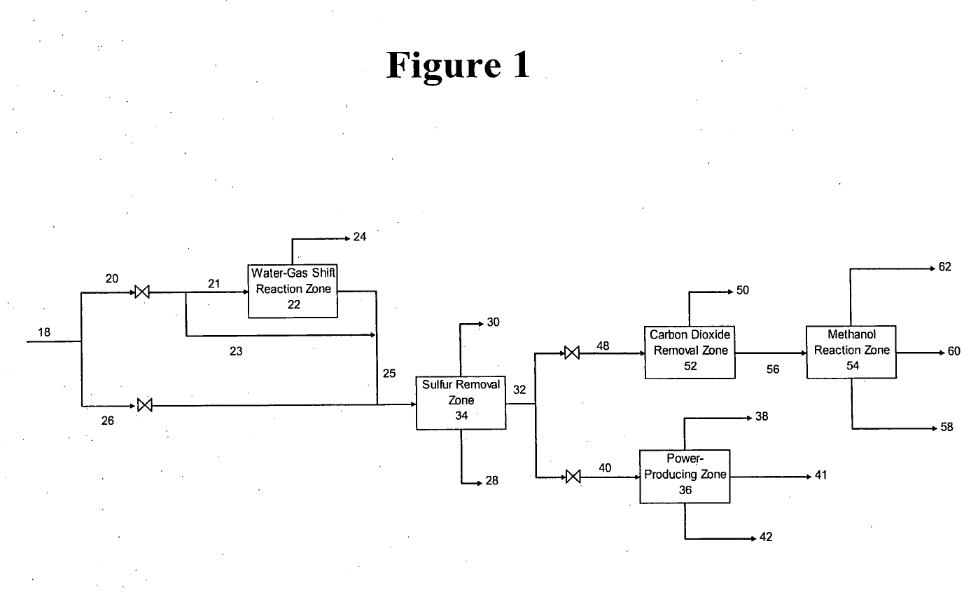

A better understanding of one embodiment of the invention is provided with particular reference to the process flow diagram depicted in FIG. 1. In the embodiment set forth in FIG. 1, the syngas derived by the reforming of hydrocarbonaceous materials or gasification of carbonaceous materials is supplied via conduit 18 at a substantially constant rate wherein the syngas is sufficient to supply 100% of the maximum capacity fuel requirements of a power producing zone. The flow of the syngas is divided between conduits 20 and 26 by flow control methods known in the art, wherein the ratio of flow to the two streams is dependent on the instantaneous power dispatch load factor. The fraction of gas directed to conduit 26 may vary from 0-100% of the flow of conduit 18. Maximum power production occurs when 100% of stream 18 is directed to conduit 40. Maximum methanol production occurs when 100% of stream 18 is directed to conduit 48.

A further description of this embodiment of the process is dependent on the power dispatch load factor. During peak power demand, 100% of stream 18 is directed through conduit 26 to a sulfur removal zone 34 and power producing zone 36. In the sulfur removal zone 34, the sulfur-containing compounds of the crude syngas are removed, e.g. hydrogen sulfide, carbonyl sulfide, as well as other trace impurities such as ammonia, hydrogen chloride, hydrogen cyanide, and trace metals such as mercury, arsenic, and the like. The sulfur removal equipment may be preceded by one or more gas cooling steps to reduce the temperature of the crude syngas as required by the particular sulfur removal technology utilized therein. Sensible heat energy from the syngas may be recovered through steam generation in the cooling train by means known in the art. The steam thus generated may be exported from the first sulfur removal zone via conduit 28.

Sulfur species, e.g., elemental sulfur, sulfuric acid, exit the sulfur removal zone via conduit 30. Environmental regulations on acid gas emissions from power generating plants typically limit sulfur content of the cleaned syngas to less 100 parts per million by volume. Elemental sulfur may be produced in sulfur removal zone 34 by any methods known in the art, for example the Claus reaction. Alternatively the sulfur may be oxidized and combined with water to produce sulfuric acid by means well known in the art.

Cleaned syngas exits the sulfur removal zone via line 32 and is diverted in full via line 40 to power producing zone 36, wherein the syngas is combusted with air, or another suitable oxygen containing gas. In the preferred power producing unit, the hot combustion gases are expanded to drive at least one gas turbine to produce electric power, exported via conduit 38. The still hot turbine exhaust gases are preferably fed to a heat recovery steam generator to produce steam, which can be exported for use in other zones of the process (via conduit 41) or to drive one or more steam turbogenerators to produce additional electricity. The clean, cooled flue gas exits through conduit 42 where it can be discharged to the atmosphere, although some remaining heat may be recovered and used as deemed advantageous in other units of the process. It is, of course, contemplated that such an arrangement, as disclosed herein, may be substantially modified according to the principles of this invention.

During periods of off-peak power demand, at least one of the combustion turbines in the power producing zone is shut down and the corresponding syngas stream is diverted to a chemical producing zone, illustrated in this embodiment by the production of methanol. The syngas stream 18 is directed through conduit 20 to a chemical producing zone comprising a water-gas shift reaction zone 22, a sulfur removal zone 34, a carbon dioxide removal zone 52, and a methanol reaction zone 54. A fraction of the gas is directed via conduit 21 to the water-gas shift reaction zone 22 and the remainder is by-passed through conduit 23. The fraction of the gas directed via conduit 21 undergoes the equilibrium-limited water-gas shift reaction over a cobalt-molybdenum catalyst. The steam generated by the heat of the exothermic shift reaction exits the water-gas shift zone via conduit 24.

Typically for maximum methanol production the fraction of stream 20 that is by-passed around the water-gas-shift zone 22 via line 23 is adjusted such that the molar composition ratio, R, of the fresh gas to the methanol reaction zone, stream 48 is between 1.8 and 2.5, more preferably the value of R is about 1.9 to 2.1. The composition ratio, R, is defined as:
R=(moles H₂−moles CO₂)/(moles CO+moles CO₂)
The shifted gas is conveyed via conduit 25 to the sulfur removal zone 34 described above wherein the sulfur bearing components of the crude syngas are removed, e.g. hydrogen sulfide, carbonyl sulfide, as well as other trace impurities such as ammonia, hydrogen chloride, hydrogen cyanide, and trace metals such as mercury, arsenic, and the like. The sulfur removal equipment may be preceded by one or more gas cooling steps to reduce the temperature of the crude syngas as required by the particular sulfur removal technology utilized therein. Sensible heat energy from the syngas may be recovered through steam generation in the cooling train by means known in the art. The steam thus generated may be exported from the first sulfur removal zone via conduit 28.

Sulfur species, e.g., elemental sulfur, sulfuric acid, exit the sulfur removal zone via conduit 30. In order to ensure proper operation of the methanol catalyst typically the sulfur content of the cleaned syngas is reduced from the level required for power generation (generally less than 100 ppm by volume) to less than 1 part per million by volume by a sulfur scavenging method that is operated only during methanol production to conserve capacity of the scavenging method. Examples of sulfur scavenging technologies are adsorption on zinc oxide, copper oxide, or iron oxide. Alternatively, if desirous from an emission standpoint, the scavenging method may be operated both during power and chemical production.

The essentially sulfur-free syngas is directed via conduit 32 to conduit 48 to carbon dioxide removal zone 52 wherein greater than 90% of the carbon dioxide in the feed gas is removed in the carbon dioxide removal zone. The carbon dioxide exits zone 52 via conduit 50 and sweet syngas is conveyed via conduit 56 to methanol reaction zone 54 wherein the feed gas is converted to methanol over a suitable catalyst. Examples of suitable catalysts are copper-based supported catalysts.

Because of the highly exothermic nature of the methanol synthesis reaction, steam may be generated by recovering from the methanol reaction zone via conduit 62. The methanol synthesis reaction may be accomplished in any reactor format known in the art for controlling the heat release of exothermic reactions. Examples of suitable reactor formats are single stage adiabatic fixed bed reactors; multiple-stage adiabatic fixed bed reactors with interstage cooling, steam generation, or cold-shotting; tubular fixed bed reactors with steam generation or cooling; fluidized beds, or slurry bed reactors. The methanol synthesis reaction may be accomplished in the vapor or liquid phase. The methanol product exits zone 54 via conduit 58.

Typically, at the reaction conditions employed, i.e., temperature of 150-260° C., and about 25 to 97 bara, the reaction of syngas components to form methanol is incomplete, and is typically 20 to 70% of the inlet gases. Therefore, it is necessary that the methanol reaction zone comprise a means for recycling unreacted gases to the reactor comprising condensation, cooling, and compression equipment. In this fashion, up to 100 mole percent of the carbon monoxide and hydrogen introduced to methanol reaction zone 54 via conduit 56 can be converted to methanol.

Tail gases are removed from reaction zone 54 via conduit 60 to control buildup of inerts (e.g. nitrogen, argon, and methane) in the methanol reaction zone. Typically, this purge is less than 5% of the flow of conduit 56. This tail gas may be utilized in the combustion turbines or for duct firing of the HRSG in combined cycle zone 36 for power production or as fuel to a separate package boiler for steam or power generation. In a further embodiment of our novel process, a portion of the syngas may be diverted from the power producing zone to the methanol reactor to maintain the reactor at elevated temperatures during periods of peak power demand. The methanol that is produced from this syngas can be passed to the power producing zone.

In another embodiment of the invention, ammonia is produced in the chemical producing zone wherein all of the crude syngas directed toward the chemical producing zone is subjected to the water gas shift reaction zone to maximize hydrogen and carbon dioxide production. Typical conversions of carbon monoxide to hydrogen and carbon dioxide are greater than 95%. The carbon dioxide removal zone may comprise conventional absorption or adsorption technologies described above, followed by final purification step. For example pressure swing adsorption, wherein the oxygenate content of the hydrogen is reduced to less than 2 ppm by volume. Ammonia may be produced in the chemical producing zone by the Haber-Bosch process by means known in the art as exemplified by LeBlance et al in “Ammonia”, Kirk-Othmer Encyclopedia of Chemical Technology, Volume 2, 3^{rd} Edition, 1978, pp., 494-500.

In another embodiment of the invention, Fischer-Tropsch products such as, for example, hydrocarbons and alcohols, can be produced in the chemical producing zone via a Fischer-Tropsch reaction as exemplified in U.S. Pat. Nos. 5,621,155 and 6,682,711. Typically, the Fischer-Tropsch reaction may be effected in a fixed bed, in a slurry bed, or in a fluidized bed reactor. The Fischer-Tropsch reaction conditions may include using a reaction temperature of between 190° C. and 340° C., with the actual reaction temperature being largely determined by the reactor configuration. For example, when a fluidized bed reactor is used, the reaction temperature is preferably between 300° C. and 340° C.; when a fixed bed reactor is used, the reaction temperature is preferably between 200° C. and 250° C.; and when a slurry bed reactor is used, the reaction temperature is preferably between 190° C. and 270° C.

An inlet synthesis gas pressure to the Fischer-Tropsch reactor of between 1 and 50 bar, preferably between 15 and 50 bar, may be used. The synthesis gas may have a H₂:CO molar ratio, in the fresh feed, of 1.5:1 to 2.5:1, preferably 1.8:1 to 2.2:1. The synthesis gas typically includes 0.1 wppm of sulfur or less. A gas recycle may optionally be employed to the reaction stage, and the ratio of the gas recycle rate to the fresh synthesis gas feed rate, on a molar basis, may then be between 1:1 and 3:1, preferably between 1.5:1 and 2.5:1. A space velocity, in m³ (kg catalyst)⁻¹ hr⁻¹, of from 1 to 20, preferably from 8 to 12, may be used in the reaction stage.

In principle, an iron-based, a cobalt-based or an iron/cobalt-based Fischer-Tropsch catalyst can be used in the Fischer-Tropsch reaction stage, although Fischer-Tropsch catalysts operated with high chain growth probabilities (i.e., alpha values of 0.8 or greater, preferably 0.9 or greater, more preferably, 0.925 or greater) are typical. Reaction conditions are preferably chosen to minimize methane and ethane formation. This tends to provide product streams which mostly include wax and heavy products, i.e., largely paraffinic C₂₀+linear hydrocarbons.

The iron-based Fischer-Tropsch catalyst may include iron and/or iron oxides which have been precipitated or fused. However, iron and/or iron oxides which have been sintered, cemented, or impregnated onto a suitable support can also be used. The iron should be reduced to metallic Fe before the Fischer-Tropsch synthesis. The iron-based catalyst may contain various levels of promoters, the role of which may be to alter one or more of the activity, the stability, and the selectivity of the final catalyst. Typical promoters are those influencing the surface area of the reduced iron (“structural promoters”), and these include oxides or metals of Mn, Ti, Mg, Cr, Ca, Si, Al, or Cu or combinations thereof.

The products from Fischer-Tropsch reactions often include a gaseous reaction product and a liquid reaction product. For example, the gaseous reaction product typically includes hydrocarbons boiling below about 343° C. (e.g., tail gases through middle distillates). The liquid reaction product (the condensate fraction) includes hydrocarbons boiling above about 343° C. (e.g., vacuum gas oil through heavy paraffins) and alcohols of varying chain lengths.

In another example, the chemical producing zone may be used to produce hydrogen by the syngas through to a water-gas shift reaction as described hereinabove. In yet another embodiment of the invention, alkyl formates such as, for example, methyl formate are produced in the chemical producing zone. There are currently several known processes for the synthesis of alkyl formates such as methyl formate from a syngas and alkyl alcohol feedstock. In addition to U.S. Pat. No. 3,716,619, they include U.S. Pat. No. 3,816,513, wherein carbon monoxide and methanol are reacted in either the liquid or gaseous phase to form methyl formate at elevated pressures and temperatures in the presence of an alkaline catalyst and sufficient hydrogen to permit carbon monoxide to be converted to methanol, and U.S. Pat. No. 4,216,339, in which carbon monoxide is reacted at elevated temperatures and pressures with a current of liquid reaction mixture containing methanol and either alkali metal or alkaline earth metal methoxide catalysts to produce methyl formate. In the broadest embodiment of this invention, however, any effective commercially viable process for the formation of an alkyl formate from a feedstock comprising a corresponding alkyl alcohol and a prepared syngas sufficiently rich in carbon monoxide is within the scope of the invention. The precise catalyst or catalysts chosen, as well as concentration, contact time, and the like, can vary widely, as is known to those skilled in the art. It is preferred to use the catalysts disclosed in U.S. Pat. No. 4,216,339, but a wide variety of other catalysts known to those in the art can also be used.

We claim:

1. A process for intermittently producing electrical power and chemicals, comprising:
(a) continuously feeding an oxidant stream comprising at least 90 volume % oxygen into one or more gasifiers;
(b) reacting said oxidant stream with a carbonaceous material in said one or more gasifiers to produce one or more synthesis gas streams comprising carbon monoxide, hydrogen, carbon dioxide, and sulfur-containing compounds;
(c) passing at least one of said synthesis gas streams to a power-producing zone comprising at least one combustion turbine during a period of peak power demand to produce electrical power;
(d) passing at least one of said synthesis gas streams to a chemical-producing zone during a period of off-peak power demand to produce chemicals; and
(e) shutting down said at least one combustion turbine during said period of off-peak power demand.

2. The process according to claim 1 wherein said chemical producing zone produces methanol, alkyl formates, dimethyl ether, ammonia, hydrogen, Fischer-Tropsch products, or a combination thereof.

3. The process according to claim 2 where said chemical producing zone is a methanol-producing zone.

4. The process according to claim 3 wherein step (e) further comprises gradually diverting all of said at least one synthesis gas stream from said at least one combustion turbine to said methanol producing zone during a transition period from peak power demand to off-peak power demand while cofeeding methanol to said at least one combustion turbine at a rate sufficient to maintain said at least one combustion turbine at 50% or more of maximum capacity before shutting down said at least one combustion turbine.

5. The process according to claim 3 further comprising: (f) gradually diverting up to 100 volume % of said at least one synthesis gas stream from said methanol producing zone to said at least one combustion turbine during a transition period from off-peak power demand to peak power demand while cofeeding methanol to said at least one combustion turbine sufficient to maintain said at least one combustion turbine at 50% or more of maximum capacity.

6. The process according to claim 3, further comprising:
(f) passing a portion of at least one of said synthesis gas streams to said methanol-producing zone during said period of peak power demand to maintain said methanol-producing zone at an elevated temperature; and
(g) passing all product from said methanol-producing zone to said power-producing zone during said period of peak power demand.

7. The process according to claim 3 wherein said methanol producing zone comprises a fixed bed or a liquid slurry phase methanol reactor having a supported or slurried catalyst therein.

8. The process according to claim 7 further comprising shutting off said passage of said synthesis gas stream to said methanol producing zone during said period of peak power demand.

9. The process according claim 8 further comprising contacting steam or hot water with at least one heat exchange surface of said fixed bed or liquid slurry phase methanol reactor to maintain said supported or slurried catalyst at a temperature of at least 150° C.

10. The process according claim 8 further comprising passing at least one heated gas stream that is unreactive under methanol reaction conditions to said fixed bed or liquid slurry phase methanol reactor to maintain said supported or slurried catalyst at a temperature of at least 150° C.

11. The process according to claim 3 wherein said methanol producing zone comprises a steam driven compressor that is supplied with steam from a heat exchanger associated with a methanol reactor, a water-gas shift reactor, a gasifer, a heat recovery steam generator, or a combination thereof during said periods of peak and off-peak power demand.

12. The process according to claim 1, wherein said oxidant stream comprises at least 95 volume % oxygen.

13. The process according to claim 12, wherein said oxidant stream comprises at least 98 volume % oxygen.

14. The process according to claim 1 further comprising removing at least 95 mole percent of the total sulfur-containing compounds present in said synthesis gas streams in a sulfur-removal zone before step (c) or (d).

15. The process according to claim 14 comprising removing at least 99 mole percent of the total sulfur-containing compounds in said synthesis gas streams.

16. The process according to claim 3 further comprising removing said carbon dioxide from said at least one of synthesis gas stream to give a carbon dioxide concentration of about 0.5 to about 10 mole %, based on the total moles of gas in said at least one synthesis gas stream, before passing to said methanol-producing zone of step (d).

17. The process according to claim 16 wherein said carbon dioxide concentration is about 2 to about 5 mole %.

18. The process according to claim 1 further comprising passing up to 100 volume % of said at least one synthesis gas stream to a water-gas shift reaction zone before step (c) or (d) wherein at least a portion of said carbon monoxide is reacted with water to produce hydrogen and carbon dioxide.

19. The process according to claim 1, wherein said carbonaceous material is coal or petroleum coke.

20. The process according to claim 1, wherein said power-producing zone comprises a combined cycle system.

21. The process according to claim 1 wherein said combustion turbine operates at least at 70% of its maximum capacity during step (c).

22. The process according to claim 1 wherein said one or more gasifiers are sized to supply at least 90% of the maximum capacity fuel requirements of said power-producing zone.

23. The process according to claim 18 wherein said one or more gasifiers are sized to supply at least 95% of the maximum capacity fuel requirements of said power-producing zone.

24. A process for intermittently producing electrical power and methanol, comprising:
(a) continuously feeding an oxidant stream comprising at least 90 volume % oxygen into one or more gasifiers;
(b) reacting said oxidant stream with a carbonaceous material in said one or more gasifiers to produce one or more synthesis gas streams comprising carbon monoxide, hydrogen, carbon dioxide, and sulfur-containing compounds;
(c) passing at least one of said synthesis gas streams to a power-producing zone comprising at least one combustion turbine during a period of peak power demand to produce electrical power;
(d) gradually diverting all of said at least one synthesis gas stream from said at least one combustion turbine to a methanol producing zone during a transition period from peak power demand to off-peak power demand while cofeeding methanol to said combustion turbine at a rate sufficient to maintain said at least one combustion turbine at 50% or more of maximum capacity;
(e) shutting down said at least one combustion turbine during said period of off-peak power demand;
(f) passing at least one of said synthesis gas streams to said methanol-producing zone during a period of off-peak power demand to produce methanol; and
(g) gradually diverting up to 100 volume % of said at least one synthesis gas stream from said methanol producing zone to said at least one combustion turbine during a transition period from off-peak power demand to peak power demand while cofeeding methanol to said at least one combustion turbine sufficient to maintain said combustion turbine at 50% or more of maximum capacity.

25. A method for maximizing monetary value of a synthesis gas stream from a gasification process, comprising:
(a) continuously feeding an oxidant stream comprising at least 95% oxygen into a gasifier;
(b) reacting said oxidant stream with a carbonaceous material in said gasifier to produce a synthesis gas stream;
(c) passing said synthesis gas stream to a power-producing zone comprising at least one combustion turbine during a period of peak power demand;
(d) passing said synthesis gas stream to a methanol-producing zone during a period of off-peak power demand; and
(e) shutting down said at least one combustion turbine during said period of off-peak power demand.

26. The method according to claim 25 wherein step (e) further comprises gradually diverting all of said synthesis gas stream from said at least one combustion turbine to said methanol producing zone during a transition period from peak power demand to off-peak power demand while cofeeding methanol to said at least one combustion turbine at a rate sufficient to maintain said at least one combustion turbine at 50% or more of maximum capacity before shutting down said at least one combustion turbine.

27. The method according to claim 25, further comprising:
(f) passing a portion of said synthesis gas stream to said methanol-producing zone during said period of peak power demand to maintain said methanol-producing zone at an elevated temperature; and
(g) passing all product from said methanol-producing zone to said power-producing zone during said period of peak power demand.

28. The method according to claim 25 wherein said methanol producing zone comprises a fixed bed or a liquid slurry phase methanol reactor having a supported or slurried catalyst therein.

29. The method according to claim 28 further comprising valving-off said fixed bed or liquid slurry phase methanol reactor during said period of peak power demand.

30. The method according claim 28 further comprising contacting steam or hot water with at least one heat exchange surface of said fixed bed or liquid slurry phase methanol reactor to maintain said supported or slurried catalyst at a temperature of at least 150° C.

31. The method according claim 28 further comprising passing at least one heated gas stream that is unreactive under methanol reaction conditions to said fixed bed or liquid slurry phase methanol reactor to maintain said supported or slurried catalyst at a temperature of at least 150° C.

32. The method according to claim 25 wherein said methanol producing zone comprises a steam driven compressor that is supplied with steam from a heat exchanger associated with a methanol reactor, a water-gas shift reactor, a gasifer, a heat recovery steam generator, or a combination thereof during said periods of peak and off-peak power demand.

33. The method according to claim 25, wherein said oxidant stream comprises at least 95 volume % oxygen.

34. The method accroding to claim 33, wherein said oxidant stream comprises at least 98 volume % oxygen.

35. The method according to claim 25 further comprising removing at least 95 mole percent of the total sulfur-containing compounds present in said synthesis gas stream in a sulfur-removal zone before step (c) or (d).

36. The method according to claim 35 comprising removing at least 99 mole percent of the total sulfur-containing compounds in said synthesis gas streams.

37. The method according to claim 25 wherein said synthesis gas streams comprise about 0.5 to about 10 mole % carbon dioxide before passing to said methanol-producing zone of step (d).

38. The method according to claim 37 wherein said synthesis gas streams comprise about 2 to about 5 mole % carbon dioxide before passing to said methanol-producing zone of step (d).

39. The method according to claim 25 further comprising passing said synthesis gas streams to a water-gas shift reaction zone before step (c) or (d) wherein at least a portion of said carbon monoxide is reacted with water to produce hydrogen and carbon dioxide.

40. The method according to claim 25, wherein said carbonaceous material is coal or petroleum coke.

41. The method according to claim 25, wherein said power-producing zone comprises a combined cycle system.

42. The method according to claim 25 wherein said combustion turbine operates at least at 70% of its maximum capacity during step (c).

43. The method according to claim 25 wherein said gasifiers are sized to supply at least 90% of the maximum capacity fuel requirements of said power-producing zone.

44. The method according to claim 43 wherein said gasifiers are sized to supply at least 95% of the maximum capacity fuel requirements of said power-producing zone.
